(19) United States
(12) Patent Application Publication
(10) Pub. No.: US 2013/0206059 A1
(43) Pub. Date: Aug. 15, 2013

(54) DIP COATING SYSTEM

(71) Applicants: Joerg Robbin, Ammerbuch (DE); Martin Riegraf, Reutlingen (DE)

(72) Inventors: Joerg Robbin, Ammerbuch (DE); Martin Riegraf, Reutlingen (DE)

(73) Assignee: EISENMANN AG, Böblingen (DE)

(21) Appl. No.: 13/821,678

(22) PCT Filed: Aug. 18, 2011
(86) PCT No.: PCT/EP2011/004161

§ 371 Date: Apr. 24, 2013

(30) Foreign Application Priority Data
Sep. 10, 2010 (DE) 20 2010 012 481.6

(51) Int. Cl. B05C 13/02

(52) U.S. Cl. CPC B05C 13/02
USPC 118/423

(57) ABSTRACT

A dip coating system in which objects to be treated are transported by means of at least one conveyor carriage to the dipping tanks which can be filled with a treatment liquid, are dipped therein, and then withdrawn and can be conveyed away from the dipping tanks. Said conveyor carriage can be guided along a rail and comprises a drive carriage, and a securing device to which at least one object can be secured and which can be rotated about a rotational axis. A connection device joins the drive carriage to the securing device. An end of the rotational axis can be mounted on the connection device such that the rotational axis can be displaced in the vertical direction freely overhanging together with the connection device. Said connection device comprises a drive device which can rotate the rotational axis. Said rotational axis and drive device are joined by a planetary gearing.

The invention relates to a dip coating system having
a) at least one dip tank which can be filled with a treatment liquid into which the objects to be treated, in particular motor vehicle bodies, can be dipped;
b) at least one transport carriage which is displaceable along a rail extending on one side of the dip tank and which comprises:
   ba) a drive carriage which can be displaced along the rail by means of a motor;
   bb) a securing device to which at least one object can be secured and which is rotatable about a rotary axle;
   bc) a connecting device which connects the drive carriage to the securing device and on which one of the two ends of the rotary axle is so mounted that the rotary axle, projecting freely, is movable in the vertical direction together with the securing device, and which has a drive device by means of which the rotary axle is rotatable.

WO 2009/083081 A describes two different constructions of dip treatment systems. In the first of the two constructions, the drive carriage, to which the securing device for the objects to be treated is attached by way of the connecting device, moves approximately centrally over the dip baths; the weight of the securing device together with the motor vehicle body is passed at least partially into two guide rails which extend on both sides of the dip tank. This construction has the advantage that no appreciable bending moments act on the connecting device, which in this case is in the form of a frame.

The second exemplary embodiment described in WO 2009/083081 A corresponds to the type mentioned at the beginning. Here, a rail is provided on only one side of the dip tank, on which rail the drive carriage moves. The connecting device too is located substantially on only one side of the dip tank. The rotary axle is mounted in the connecting device on one side and projects freely therefrom in the direction over the dip tank. This construction is slightly less expensive than the first-described construction; however, higher bending moments have to be absorbed by the connecting device.

A second structural difference between the two exemplary embodiments of WO 2009/083081 A is that, in the first exemplary embodiment, the geometric axis of rotation is to pass substantially through the centre of gravity of the arrangement consisting of the securing device and the object to be treated. In that manner, the turning moments required for the active rotation of the securing device and the object to be treated and optionally also for holding the securing device and the object to be treated in a specific angular position are reduced. In the second exemplary embodiment, on the other hand, the relative position of the axis of rotation and the centre of gravity of the arrangement consisting of the object to be treated and the securing device is not considered; nor is a compensating weight present. This means that, in this case, high turning moments must be transmitted between the drive device and the securing device. WO 2009/083081 A does not describe in detail how this is achieved.

It is an object of the present invention to configure a dip treatment system of the type mentioned at the beginning in such a manner that the transmission of high turning moments from the drive device to the securing device is possible without consideration of the relative position of the rotary axle and the centre of gravity of the arrangement consisting of the object to be treated and the securing device and without compensating weights.

The object is achieved according to the invention in that
a) the rotary axle is connected to the drive device located in the connecting device by way of a planetary gear.

With the aid of the planetary gear it is not only possible to transmit from the drive device to the moving device a turning moment that is sufficient for rotation even in poorly balanced circumstances and with the object to be treated in the dipped state; the reverse turning moment, which is attributable to the centre of gravity of the object held in a specific angular position together with the securing device, can also be absorbed in this manner without special additional measures.

An exemplary embodiment of the invention will be described in detail hereinbelow with reference to the drawings, in which:

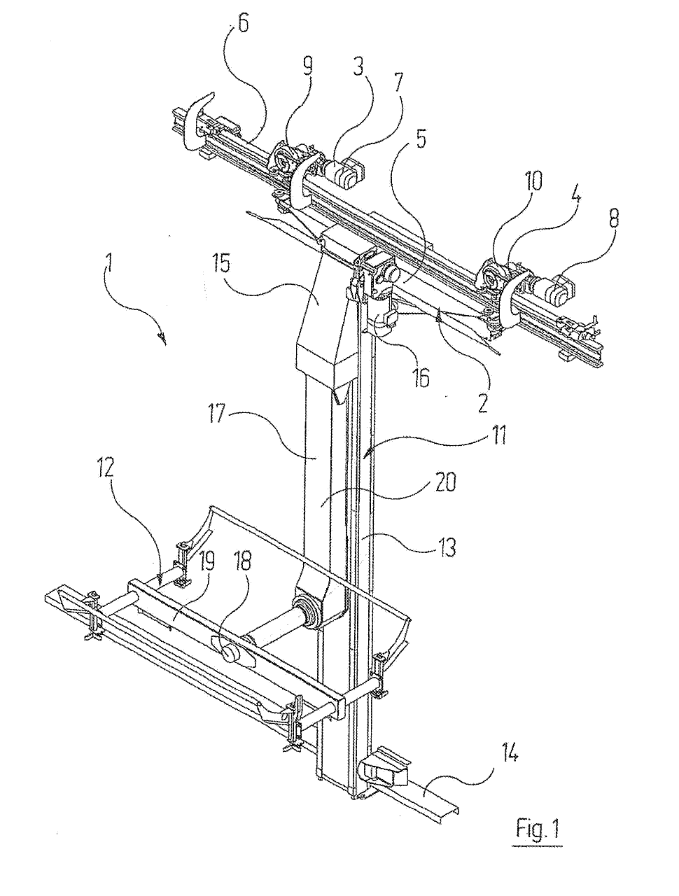

FIG. 1 shows in perspective a transport carriage as is used in a dip coating system;

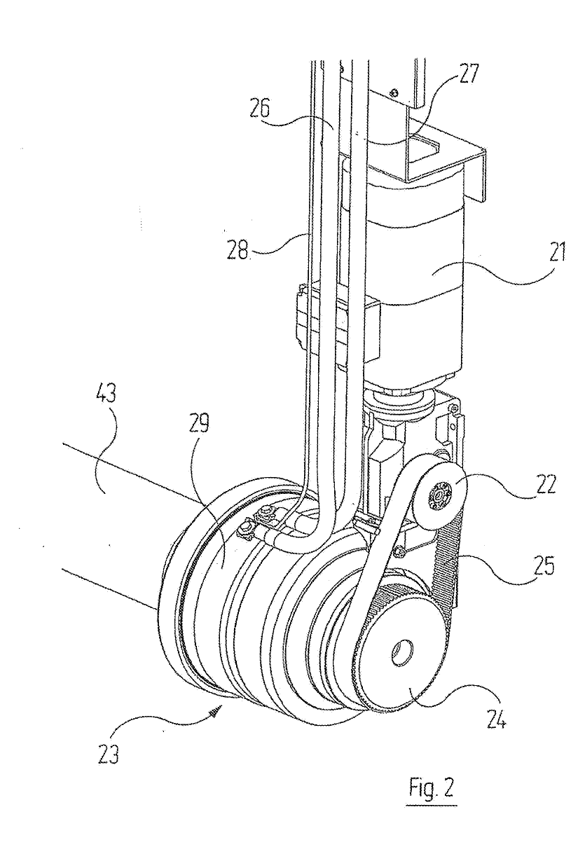

FIG. 2 shows in perspective and on an enlarged scale, and with the outer casing removed, a detail of the transport carriage of FIG. 1;

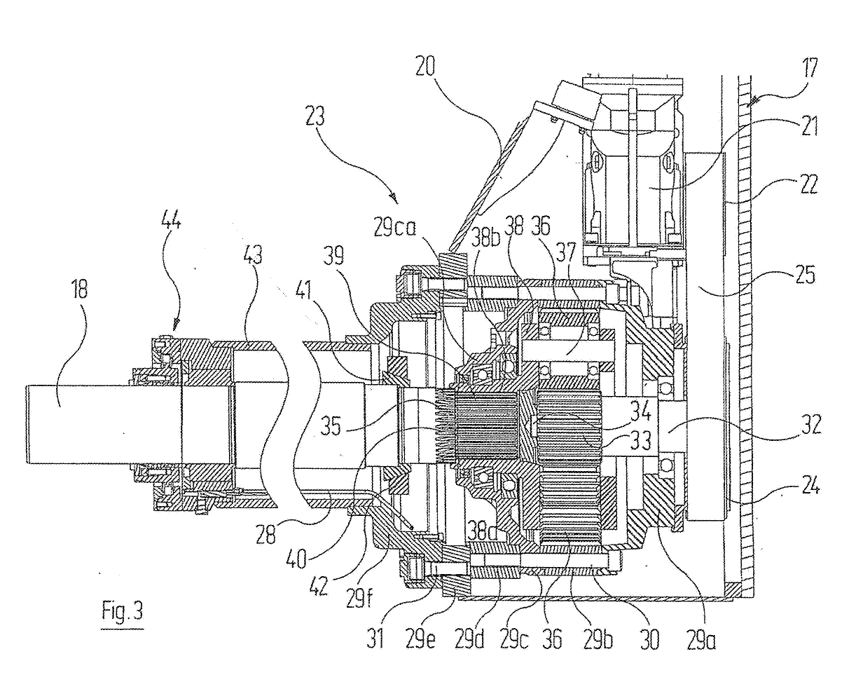

FIG. 3 shows an axial section through the bearing region for a rotary axle of the transport carriage of FIG. 1;

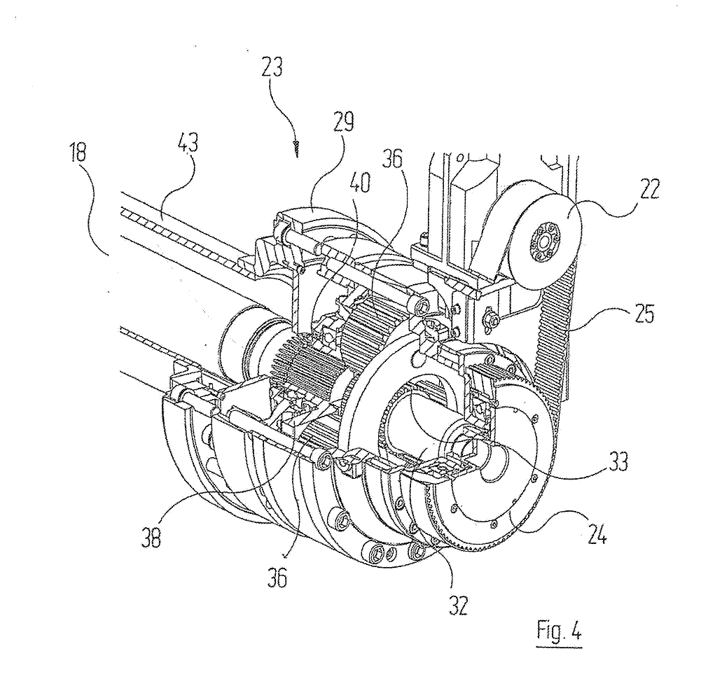

FIG. 4 shows in perspective and in a cutaway view the bearing region which is shown in section in FIG. 3;

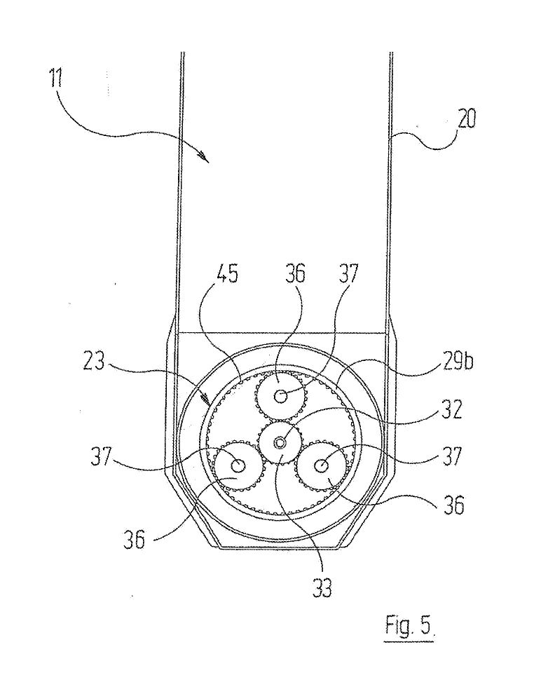

FIG. 5 shows schematically, with the omission of unnecessary details, a section according to line V-V of FIG. 3.

In FIG. 1, a transport carriage as is used in dip treatment systems, in particular in dip coating systems, is shown in perspective and is identified generally by the reference numeral 1. Details of such a dip treatment or dip coating system will be found in WO 2009/083081 A mentioned at the beginning. In the present case, it is sufficient to know that the transport carriage 1 serves to guide objects, in the present exemplary embodiment motor vehicle bodies, through a dip treatment system which comprises at least one dip tank filled with a medium, for example a liquid paint. With the aid of the transport carriage 1, the motor vehicle bodies are brought up to the dip tank, dipped into the liquid paint, optionally moved to and fro therein, removed from the liquid paint and then transported further to the next treatment station, which can be, for example, a further dip tank.

The kinematics of the motor vehicle body which can be realised in this operation with the transport carriage 1 can be understood as being a superposition of a linear movement in the transport direction, a vertical movement and a rotary movement.

With regard to the transport carriage 1 shown concretely in the drawing, it comprises a drive carriage 2, which is in the form of the drive carriage of a conventional electrified overhead monorail. This means that the drive carriage 2 has a leader 3 and a trailer 4, which are connected together by a longitudinal crosspiece 5. Both the leader 3 and the trailer 4 are equipped in known manner with guide rollers, with the aid of which the transport carriage 1 is able to move on a rail 6. Electric motors 7, 8 of the leader 3 and of the trailer 4 drive drive rollers 9, 10, which roll on the upper side of the rail 6.

The drive carriage 2 is connected by way of a connecting device 11 to a holding frame 12 which serves as a securing device and on which a motor vehicle body (not shown) can be secured in known manner directly or with the aid of a skid.

The connecting device 11 comprises a vertical guide 13, which can be supported at its bottom end on an auxiliary rail 14 by way of rollers (not shown). The auxiliary rail 14 extends in a fixed manner beneath the rail 6, parallel thereto. It serves to absorb tipping moments which act on the vertical guide 13 on account of the weight of the holding frame 12 and the motor vehicle body secured thereto.

A slide 15 as a further component of the connecting device 11 is displaceable in the perpendicular direction on the vertical guide 13. Details of the guiding of the slide 15 on the vertical guide 13 and the nature of the drive that effects the vertical movement of the slide 15 are not of interest here. The electric geared motor 16 used for that purpose is shown in FIG. 1.

Secured to the slide 15 is a carrier arm 17 which extends downwards, parallel to the vertical guide 13, and on the bottom end of which there is mounted, in a manner which will be described in greater detail hereinbelow, a rotary axle 18 which is connected in a rotationally secure manner to a longitudinal crosspiece 19 of the holding frame 12.

The arrangement is such that the weight of the holding frame 12 with the motor vehicle body secured thereto is supported by the rotary shaft 18, so that the vertical position of the holding frame 12 can be changed by displacing the slide 15 on the vertical guide 13, and the holding frame 12 with the motor vehicle body can be rotated as a whole by rotating the rotary shaft 18. The degrees of freedom required to achieve the above-mentioned superposed resulting movement of the holding frame 12 and the body secured thereto are accordingly provided by the displaceability of the drive carriage 2, and hence of the transport carriage 1 as a whole, on the rail 6, by the displaceability of the slide 15 along the vertical guide 13, and by the rotatability of the rotary axle 18.

With reference to FIGS. 2 to 5, it will now be described in detail how the rotary axle 18 is mounted in the bottom region of the carrier arm 17 and driven.

In FIG. 1, the carrier arm 17 is shown with a casing 20, which is in liquid- and gas-tight form and accordingly prevents in particular the penetration of paint into its interior. The casing 20 has been omitted in FIG. 2, so that various components provided in the bottom region of the carrier arm 17 are visible. Firstly, there can be seen an electric geared motor 21, on the output shaft of which there is seated a toothed belt disc 22. Coaxially with the rotary axle 18 there is arranged a planetary gear, which is identified generally by the reference numeral 23. On the input shaft 32 of the planetary gear 23, that is to say on its “sun shaft”, there is seated a further toothed belt disc 24, which is connected by way of a toothed belt 25 to the toothed belt disc 22 of the electric geared motor 21.

In FIG. 2 there can additionally be seen two solid copper feed lines 26, 27, by way of which the operating current required for electrophoretic dip coating is fed in a manner which will be described hereinbelow to the motor vehicle body secured to the holding frame 12. In addition, a thin tube 28 is shown in FIGS. 2 and 3, by way of which compressed air or another sealing medium can be introduced into the interior of a bearing and sealing arrangement 44, which will be discussed in detail hereinbelow.

The internal structure of the planetary gear 23 is shown in FIGS. 3 and 4, to which reference will now be made.

The gear housing 29 is composed of a plurality of parts 29a, 29b, 29c, 29d, 29e and 29f, which are held together in a suitable manner with the aid of threaded bolts 30, 31. The sun shaft 32 of the planetary gear 23 is mounted in the part 29a of the gear housing 29 that is located closest to the toothed belt disc 24. It carries the sun wheel 33 in its inside end region in a known manner. The inner end of the sun shaft 32 is formed by a cylindrical, coaxial prolongation 34, which engages in a complementary opening of a bearing plate 35. The sun wheel 33 meshes with three planetary wheels 36, which are mounted on shafts 37 which in known manner lie parallel to the sun shaft 33. Part 29b of the gear housing 29 is provided with internal toothing 45 and serves as a stationary, that is to say non-rotating, hollow wheel with which the planetary wheels 36 mesh. This can be seen in particular in FIG. 5.

The axles 37 of the planetary wheels 36 are secured to a planetary carrier 38, which itself comprises an annular flange 38a, which surrounds and centres the bearing plate 35, and, integral with the annular flange 38a, an axially extending, cylindrical connection region 38b. The connection region 38b of the planetary carrier 38 is mounted in housing part 29c with the aid of bearings, which can be seen in FIG. 3 but, for reasons of clarity of the drawing, are not provided with reference numerals, housing part 29c having for that purpose a correspondingly configured region 29ca which extends radially inwards.

The inner bore of the connection region 38b of the planetary carrier 28 is provided with splines 39. The end of the rotary axle 18 located on the inside of the gear housing 29 is provided with complementary splines 40 and is so inserted into the inner bore of the planetary carrier 38 that there is a rotationally secure connection between the planetary carrier 38 and the rotary axle 18.

In the region of the rotary axle 18 that is surrounded by part 29f of the gear housing 29 there are provided an annular sliding contact 41, which is connected in a rotationally secure manner to the rotary axle 18, and a stationary sliding contact 42, which is in contact with the annular sliding contact 41 and is connected in a suitable manner to the gear housing 29. The stationary sliding contact 42 is electrically connected to the power lines 26, 27 in a manner that is not apparent from the drawings.

To the terminal part 29f of the gear housing 29 facing the holding frame 12 there is secured a stationary protective tube 43, which surrounds the rotary axle 18 until close to its end at which the rotary axle 18 is connected to the holding frame 12. The protective tube 43 carries at its free end a bearing and sealing device 44 which, as is shown by its name, on the one hand serves as a bearing for the rotary axle 18 again and on the other hand prevents the penetration of coating liquid into the interior of the protective tube 43 and accordingly into the interior of the planetary gear 23 and the escape of compressed air from the protective tube 43 and the interior of the planetary gear 23.

The above-described transport carriage 1 operates as follows:

The transport carriage 1 with a motor vehicle body secured to the holding frame 12 is moved by the drive carriage 2 over a dip tank into which the motor vehicle body is to be dipped. The slide 15 is thereby moved sufficiently high on the vertical guide 13 that the holding frame 12 and the motor vehicle body are at a sufficient distance from system components arranged beneath them. When a position of the transport carriage 1 above the dip tank has been reached, the slide 15 is displaced downwards, during which the translational movement of the transport carriage 1 along the rail 6 can be interrupted or continued, as desired. By lowering the slide 15 and the carrier arm 17 secured thereto, the holding frame 12 with the motor vehicle body is dipped into the coating liquid located in the dip tank. At the same time as this vertical movement, or at a different time, the rotary axle 18 is rotated by way of the planetary gear 23 with the aid of the electric geared motor 21, which results in a corresponding rotation of the holding frame 12 and of the motor vehicle body secured thereto. Examples of kinematics that can be achieved in that manner for such a dipping movement are to be found in WO 2009/083081 A mentioned above.

The motor vehicle body is generally not secured to the holding frame 12 in such a manner that a turning moment balance is achieved with respect to the rotary axle 18. This means in particular that the rotary axle 18 does not pass through the centre of gravity of the arrangement formed by the motor vehicle body and the holding frame 12. Nor is a compensating weight, which could compensate for this turning moment, provided. However, by mounting the rotary axle 18 and its drive by way of the planetary gear 23, it is ensured that the high turning moments required for rotation of the motor vehicle body can be transmitted and that, vice versa, a turning moment that is exerted on the rotary axle 18 by the arrangement consisting of the motor vehicle body and the holding frame 12, for example when the system is at a standstill, can be absorbed in the planetary gear 23.

1. A dip treatment system comprising:
a) at least one dip tank which is capable of being filled with a treatment liquid and into which objects to be treated are capable of being dipped;
b) at least one transport carriage which is displaceable along a rail extending on a side of the dip tank and which comprises:
ba) a drive carriage which is capable of being displaced along the rail by means of a motor;
bb) a securing device to which at least one object is capable of being secured and which is rotatable about a rotary axle;
bc) a connecting device which connects the drive carriage to the securing device and on which an end of the axle is mounted such that the rotary axle, projecting freely, is movable in a vertical direction together with the securing device, and which has a drive device by means of which the rotary axle is rotatable, and wherein
c) the rotary axle is connected to the drive device located in the connecting device by way of a planetary gear.
